(19) United States
(12) Patent Application Publication
(10) Pub. No.: US 2026/0112322 A1
(43) Pub. Date: Apr. 23, 2026

(54) DATA DRIVER AND ELECTRONIC DEVICE

(71) Applicant: Samsung Display Co., LTD., Yongin-si (KR)

(72) Inventors: Mungyu Kim, Yongin-si (KR); SANG YONG NO, Yongin-si (KR); Junsoo Ko, Yongin-si (KR); Chankeun Kwon, Yongin-si (KR); Hyungseup Kim, Yongin-si (KR); Chanyeop Ahn, Yongin-si (KR); GICHANG LEE, Yongin-si (KR)

(21) Appl. No.: 19/249,137

(22) Filed: Jun. 25, 2025

(30) Foreign Application Priority Data
Oct. 18, 2024 (KR) 10-2024-0142808

(51) Int. Cl. G09G 3/3291; G09G 3/32; G09G 3/36

(52) U.S. Cl. CPC G09G 3/3291; G09G 3/32; G09G 3/3685; G09G 2310/0275; G09G 2310/0289; G09G 2310/0291; G09G 2310/0297

(57) ABSTRACT

A data driver of a display device includes first through N-th data latches, where N is an integer greater than 1, first through (N+1)-th channel circuits, a first multiplexer connected between the first through N-th data latches and the first through (N+1)-th channel circuits, and a second multiplexer connected between the first through (N+1)-th channel circuits and first through N-th data lines. In a first period, the first multiplexer connects the first through N-th data latches to the first through N-th channel circuits, respectively, and the second multiplexer connects the first through N-th data lines to the first through N-th channel circuits, respectively. In a second period, the first multiplexer connects the first through N-th data latches to second through (N+1)-th channel circuits, respectively, and the second multiplexer connects the first through N-th data lines to the second through (N+1)-th channel circuits, respectively.

This application claims priority to Korean Patent Application No. 10-2024-0142808, filed on Oct. 18, 2024, and all the benefits accruing therefrom under 35 U.S.C. § 119, the content of which in its entirety is herein incorporated by reference.

### BACKGROUND

### 1. Field

Embodiments of the present disclosure relate to a display device, and more particularly to a data driver and an electronic device including the data driver.

### 2. Description of the Related Art

In general, a display device may include a display panel that includes a plurality of pixels, a data driver that provides data voltages to the plurality of pixels, a scan driver that provides scan signals to the plurality of pixels, and a controller that controls the data driver and the scan driver.

The data driver may include a plurality of channels or a plurality of channel circuits which output the data voltages to a plurality of data lines of the display panel, respectively.

### SUMMARY

In a display device, an image quality thereof may be degraded by a voltage deviation or an offset between data voltages output by a plurality of channel circuits in a data driver thereof. Further, if the offset between the data voltages output by the plurality of channel circuits is greater than a reference offset, the data driver may be discarded.

Some embodiments provide a data driver capable of reducing a voltage deviation or an offset between data voltages provided to a plurality of data lines.

Some embodiments provide an electronic device including the data driver.

According to embodiments, there is provided a data driver of a display device. The data driver includes first through N-th data latches, where N is an integer greater than 1, first through (N+1)-th channel circuits, a first multiplexer connected between the first through N-th data latches and the first through (N+1)-th channel circuits, and a second multiplexer connected between the first through (N+1)-th channel circuits and first through N-th data lines. In such embodiments, in a first period, the first multiplexer connects the first through N-th data latches to the first through N-th channel circuits, respectively, and the second multiplexer connects the first through N-th data lines to the first through N-th channel circuits, respectively. In such embodiments, in a second period, the first multiplexer connects the first through N-th data latches to second through (N+1)-th channel circuits, respectively, and the second multiplexer connects the first through N-th data lines to the second through (N+1)-th channel circuits, respectively.

In embodiments, in the first period, a K-th channel circuit among the first through (N+1)-th channel circuits may output a data voltage to a K-th data line among the first through N-th data lines, where K is an integer greater than or equal to 1 and less than or equal to N, and, in the second period, a (K+1)-th channel circuit among the first through (N+1)-th channel circuits may output a data voltage to the K-th data line.

In embodiments, a K-th channel circuit among the first through (N+1)-th channel circuits may include a level shifter which performs a level shifting operation on image data received from a K-th data latch among the first through N-th data latches in the first period, and performs a level shifting operation on image data received from a (K−1)-th data latch among the first through N-th data latches in the second period, a digital-to-analog converter which generates a data voltage by performing a digital-to-analog conversion operation on image data output from the level shifter, and an output buffer which output the data voltage to a K-th data line among the first through N-th data lines in the first period, and to output the data voltage to a (K−1)-th data line among the first through N-th data lines in the second period, where K is an integer greater than or equal to 2 and less than or equal to N.

In embodiments, the first channel circuit may not be connected to the first through N-th data latches and the first through N-th data lines in the second period, and the (N+1)-th channel circuit may not be connected to the first through N-th data latches and the first through N-th data lines in the first period.

In embodiments, the first multiplexer may include a plurality of first switches which connects the first through N-th data latches to the first through N-th channel circuits in response to a first switching signal, respectively, and a plurality of second switches which connects the first through N-th data latches to the second through (N+1)-th channel circuits in response to a second switching signal, respectively.

In embodiments, the second multiplexer may include a plurality of third switches which connects the first through N-th data lines to the first through N-th channel circuits in response to the first switching signal, respectively, and a plurality of fourth switches which connects the first through N-th data lines to the second through (N+1)-th channel circuits in response to the second switching signal, respectively.

In embodiments, the data driver may further include a switching signal generator which generates the first switching signal having an active level in the first period, and generates the second switching signal having an active level in the second period.

In embodiments, the first period and the second period may be alternated with each other per one horizontal time.

In embodiments, in an odd-numbered horizontal time of a frame period, the first through N-th channel circuits may output data voltages to the first through N-th data lines, and, in an even-numbered horizontal time of the frame period, the second through (N+1)-th channel circuits may output data voltages to the first through N-th data lines.

In embodiments, the first period and the second period may be alternated with each other per L horizontal times, where L is an integer greater than 1.

In embodiments, the first period and the second period may be alternated with each other per one frame period.

In embodiments, in an odd-numbered frame period, the first through N-th channel circuits may output data voltages to the first through N-th data lines, and, in an even-numbered frame period, the second through (N+1)-th channel circuits may output data voltages to the first through N-th data lines.

In embodiments, the first period and the second period may be alternated with each other per L frame periods, where L is an integer greater than 1.

According to embodiments, there is provided a data driver of a display device. In such embodiments, the data driver includes first through N-th data latches, where N is an integer greater than 1, first through (N+M)-th channel circuits, where M is an integer greater than 1, a first multiplexer connected between the first through N-th data latches and the first through (N+1)-th channel circuits, and a second multiplexer connected between the first through (N+1)-th channel circuits and first through N-th data lines. In such embodiments, in a (P+1)-th period, the first multiplexer connects the first through N-th data latches to (P+1)-th through (N+P)-th channel circuits, respectively, and the second multiplexer connects the first through N-th data lines to the (P+1)-th through (N+P)-th channel circuits, respectively, where P is an integer greater than or equal to 0 and less than or equal to M.

In embodiments, in the (P+1)-th period, a (K+P)-th channel circuit among the first through (N+M)-th channel circuits may output a data voltage to a K-th data line among the first through N-th data lines, where K is an integer greater than or equal to 1 and less than or equal to N.

According to embodiments, there is provided an electronic device including a processor which provides input image data, and a display device which receives the input image data from the processor, and to display an image based on the input image data. In such embodiments, the display device includes a display panel including first through N-th data lines, and a plurality of pixels connected to the first through N-th data lines, where N is an integer greater than 1, a scan driver which provides scan signals to the plurality of pixels, a data driver which provides data voltages to the plurality of pixels through the first through N-th data lines, and a controller which controls the scan driver and the data driver. In such embodiments, the data driver includes first through N-th data latches, first through (N+1)-th channel circuits, a first multiplexer connected between the first through N-th data latches and the first through (N+1)-th channel circuits, and a second multiplexer connected between the first through (N+1)-th channel circuits and the first through N-th data lines. In such embodiments, in a first period, the first multiplexer connects the first through N-th data latches to the first through N-th channel circuits, respectively, and the second multiplexer connects the first through N-th data lines to the first through N-th channel circuits, respectively. In such embodiments, in a second period, the first multiplexer connects the first through N-th data latches to second through (N+1)-th channel circuits, respectively, and the second multiplexer connects the first through N-th data lines to the second through (N+1)-th channel circuits, respectively.

In embodiments, in the first period, a K-th channel circuit among the first through (N+1)-th channel circuits may output a data voltage to a K-th data line among the first through N-th data lines, where K is an integer greater than or equal to 1 and less than or equal to N, and, in the second period, a (K+1)-th channel circuit among the first through (N+1)-th channel circuits may output a data voltage to the K-th data line.

In embodiments, a K-th channel circuit among the first through (N+1)-th channel circuits may include a level shifter which performs a level shifting operation on image data received from a K-th data latch among the first through N-th data latches in the first period, and performs a level shifting operation on image data received from a (K−1)-th data latch among the first through N-th data latches in the second period, a digital-to-analog converter which generates a data voltage by performing a digital-to-analog conversion operation on image data output from the level shifter, and an output buffer which outputs the data voltage to a K-th data line among the first through N-th data lines in the first period, and outputs the data voltage to a (K−1)-th data line among the first through N-th data lines in the second period, where K is an integer greater than or equal to 2 and less than or equal to N.

In embodiments, the first multiplexer may include a plurality of first switches which connects the first through N-th data latches to the first through N-th channel circuits in response to a first switching signal, respectively, and a plurality of second switches which connects the first through N-th data latches to the second through (N+1)-th channel circuits in response to a second switching signal, respectively. In such embodiments, the second multiplexer may include a plurality of third switches which connects the first through N-th data lines to the first through N-th channel circuits in response to the first switching signal, respectively, and a plurality of fourth switches which connects the first through N-th data lines to the second through (N+1)-th channel circuits in response to the second switching signal, respectively.

In embodiments, the data driver may further include a switching signal generator which generates the first switching signal having an active level in the first period, and generates the second switching signal having an active level in the second period.

As described above, in a data driver and an electronic device according to embodiments, the data driver may include first through (N+1)-th channel circuits with respect to first through N-th data lines, where N is an integer greater than 1. In a first period, the first through N-th channel circuits may output data voltages to the first through N-th data lines, respectively. In a second period, second through (N+1)-th channel circuits may output data voltages to the first through N-th data lines, respectively. Accordingly, a voltage deviation or an offset between the data voltages output to the first through N-th data lines may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a data driver according to embodiments.

FIG. 2 is a circuit diagram for describing an example of an operation of a data driver of FIG. 1 in a first period.

FIG. 3 is a circuit diagram for describing an example of an operation of a data driver of FIG. 1 in a second period.

FIG. 4 is a diagram for describing an example of data voltages output from a data driver of FIG. 1.

FIG. 5 is a signal timing diagram for describing an example of an operation of a data driver according to embodiments.

FIG. 6 is a signal timing diagram for describing another example of an operation of a data driver according to embodiments.

FIG. 7 is a signal timing diagram for describing still another example of an operation of a data driver according to embodiments.

FIG. 8 is a signal timing diagram for describing still another example of an operation of a data driver according to embodiments.

FIG. 9 is a block diagram illustrating a data driver according to embodiments.

FIG. 10 is a signal timing diagram for describing an example of an operation of a data driver according to embodiments.

FIG. 11 is a signal timing diagram for describing another example of an operation of a data driver according to embodiments.

FIG. 12 is a block diagram illustrating a display device according to embodiments.

FIG. 13 is a block diagram illustrating an electronic device including a display device according to embodiments.

FIG. 14 is a block diagram illustrating an example of an electronic device according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments will be described in detail with reference to the accompanying drawings.

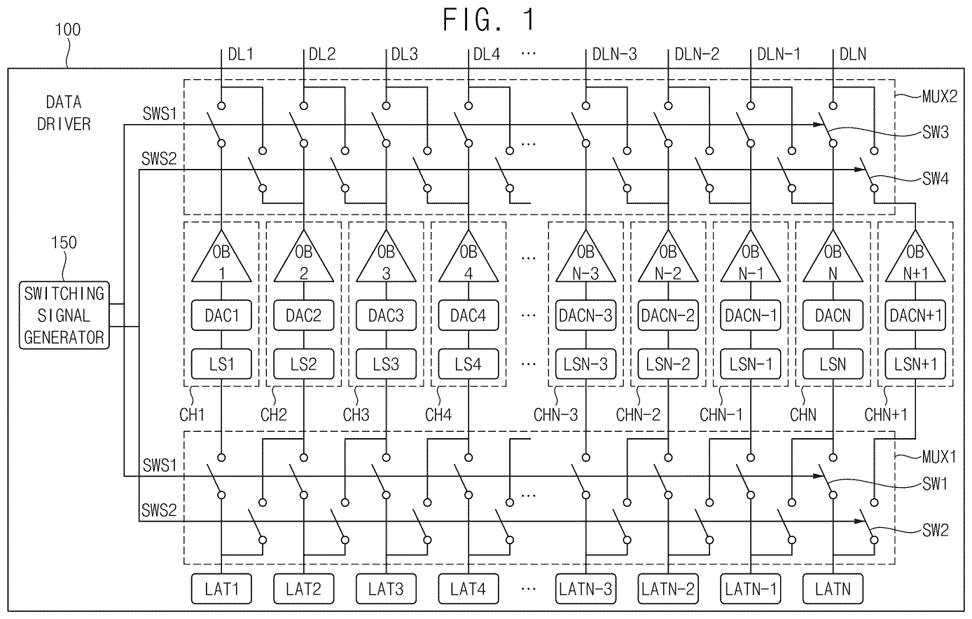

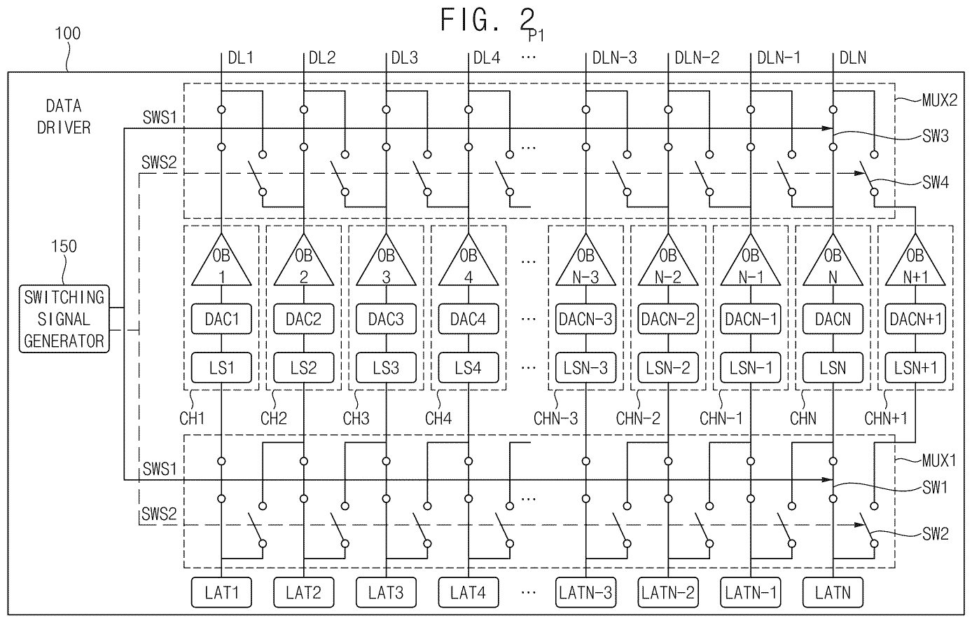

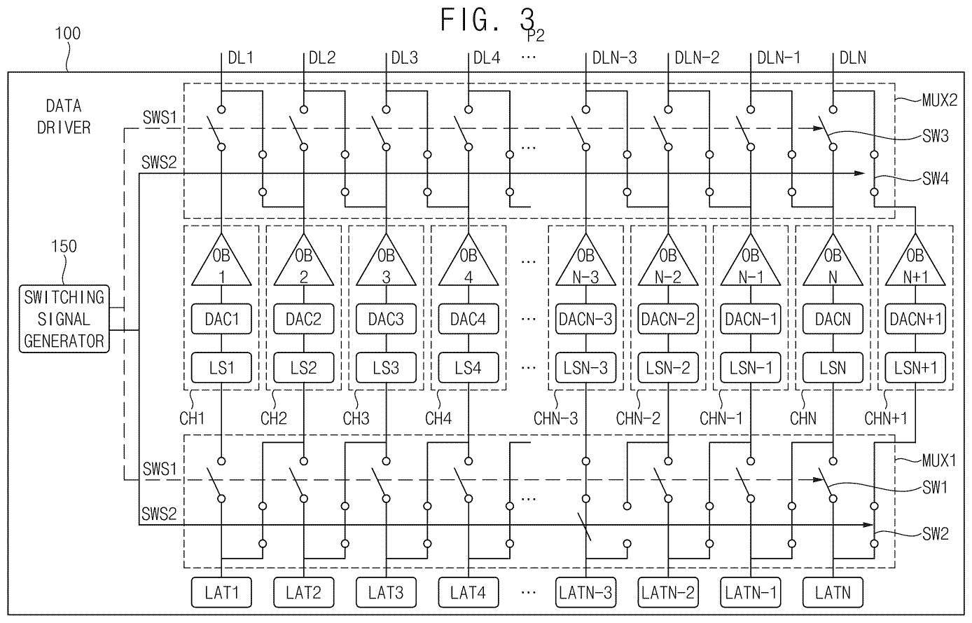

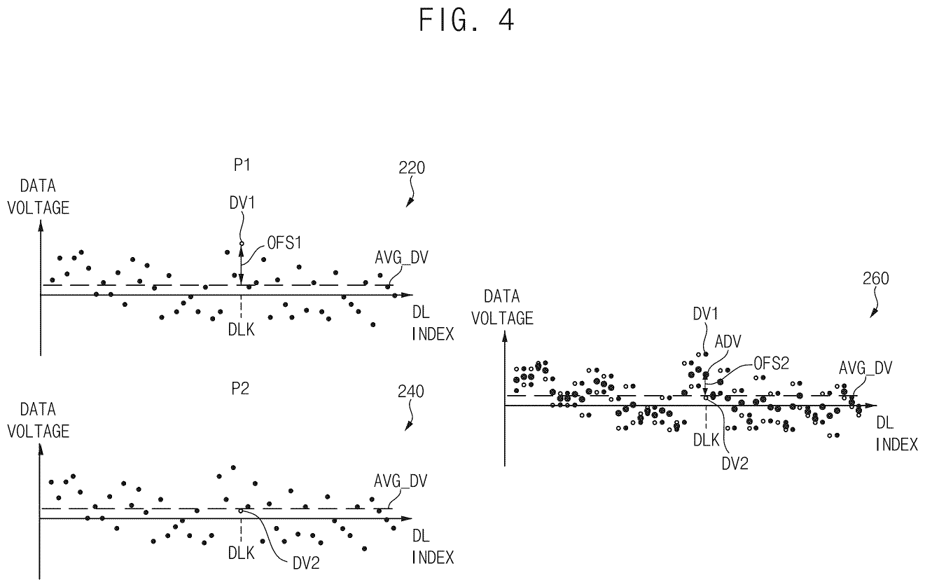

FIG. 1 is a block diagram illustrating a data driver according to embodiments, FIG. 2 is a circuit diagram for describing an example of an operation of a data driver of FIG. 1 in a first period, FIG. 3 is a circuit diagram for describing an example of an operation of a data driver of FIG. 1 in a second period, and FIG. 4 is a diagram for describing an example of data voltages output from a data driver of FIG. 1.

Referring to FIG. 1, a data driver 100 according to embodiments may include first through N-th data latches LAT1, LAT2, LAT3, LAT4, . . . , LATN-3, LATN-2, LATN-1 and LATN, where N is an integer greater than 1, a first multiplexer MUX1, first through (N+1)-th channel circuits CH1, CH2, CH3, CH4, . . . , CHN-3, CHN-2, CHN-1, CHN and CHN+1, a second multiplexer MUX2 and a switching signal generator 150.

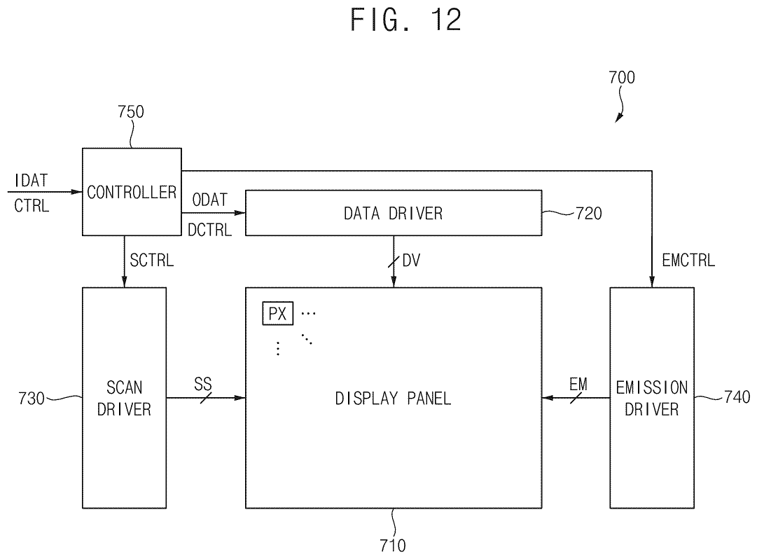

The first through N-th data latches LAT1 through LATN may store image data (e.g., output image data ODAT illustrated in FIG. 12) received from a controller (e.g., a controller 750 illustrated in FIG. 12). In an embodiment, for example, the first through N-th data latches LAT1 through LATN may store image data for one pixel row connected to first through N-th data lines DL1, DL2, DL3, DL4, . . . , DLN-3, DLN-2, DLN-1 and DLN of a display panel in each horizontal time (or horizontal period). In some embodiments, the data driver 100 may further include, but is not limited to, a shift register that sequentially generates sampling signals, and a plurality of sampling latches that sample the image data received from the controller in response to the sampling signals. The first through N-th data latches LAT1 through LATN may receive and store the image data from the plurality of sampling latches in response to a load signal.

The first multiplexer MUX1 may be connected between the first through N-th data latches LAT1 through LATN and the first through (N+1)-th channel circuits CH1 through CHN+1. The first multiplexer MUX1 may respectively connect the first through N-th data latches LAT1 through LATN to the first through N-th channel circuits CH1 through CHN in a first period, and may respectively connect the first through N-th data latches LAT1 through LATN to second through (N+1)-th channel circuits CH2 through CHN+1 in a second period. In some embodiments, to perform such operations, the first multiplexer MUX1 may include N first switches SW1 that respectively connect the first through N-th data latches LAT1 through LATN to the first through N-th channel circuits CH1 through CHN in response to a first switching signal SWS1 having an active level (e.g., a high level) in the first period, and N second switches SW2 that respectively connect the first through N-th data latches LAT1 through LATN to the second through (N+1)-th channel circuits CH2 through CHN+1 in response to a second switching signal SWS2 having the active level in the second period.

The first through (N+1)-th channel circuits CH1 through CHN+1 may receive the image data from the first through N-th data latches LAT1 through LATN through the first multiplexer MUX1, and may output data voltages corresponding to the image data to the first through N-th data lines DL1 through DLN through the second multiplexer MUX2. In some embodiments, the first through (N+1)-th channel circuits CH1 through CHN+1 may include first through (N+1)-th level shifters LS1, LS2, LS3, LS4, . . . , LSN-3, LSN-2, LSN-1, LSN and LSN+1, first through (N+1)-th digital-to-analog converters DAC1, DAC2, DAC3, DAC4, . . . , DACN-3, DACN-2, DACN-1, DACN and DACN+1, and first through (N+1)-th output buffers OB1, OB2, OB3, OB4, . . . , OBN-3, OBN-2, OBN-1, OBN and OBN+1.

In an embodiment, for example, a K-th channel circuit (e.g., a second channel circuit CH2) among the first through (N+1)-th channel circuits CH1 through CHN+1, where K is an integer greater than or equal to 2 and less than or equal to N, may include a level shifter (e.g., a second level shifter LS2), a digital-to-analog converter (e.g., a second digital-to-analog converter DAC2), and an output buffer (e.g., a second output buffer OB2). The level shifter (e.g., the second level shifter LS2) may perform a level shifting operation on image data received from a K-th data latch (e.g., a second data latch LAT2) in the first period, and may perform a level shifting operation on image data received from a (K−1)-th data latch (e.g., the first data latch LAT1) in the second period. The digital-to-analog converter (e.g., the second digital-to-analog converter DAC2) may generate a data voltage by performing a digital-to-analog conversion operation on image data output from the level shifter (e.g., the second level shifter LS2). The output buffer (e.g., the second output buffer OB2) may output the data voltage to a K-th data line (e.g., a second data line DL2) in the first period, and output the data voltage to a (K−1)-th data line (e.g., the first data line DL1) in the second period.

The second multiplexer MUX2 may be connected between the first through (N+1)-th channel circuits CH1 through CHN+1 and the first through N-th data lines DL1 through DLN. The second multiplexer MUX2 may respectively connect the first through N-th data lines DL1 through DLN to the first through N-th channel circuits CH1 through CHN in the first period, and may respectively connect the first through N-th data lines DL1 through DLN to the second through (N+1)-th channel circuits CH2 through CHN+1 in the second period. In some embodiments, to perform such operations, the second multiplexer MUX2 may include N third switches SW3 that respectively connect the first through N-th data lines DL1 through DLN to the first through N-th channel circuits CH1 through CHN in response to the first switching signal SWS1 having the active level in the first period, and N fourth switches SW4 that respectively connect the first through N-th data lines DL1 through DLN to the second through (N+1)-th channel circuits CH2 through CHN+1 in response to the second switching signal SWS2 having the active level in the second period.

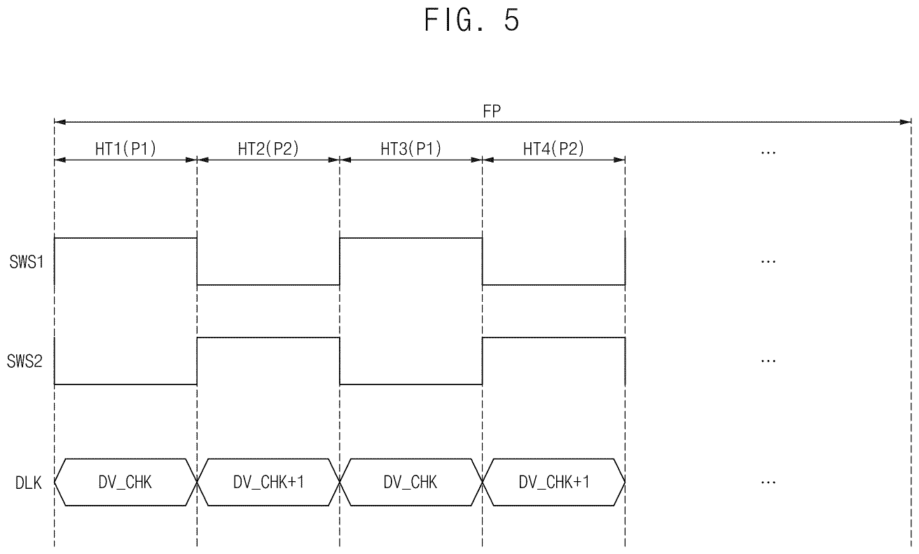

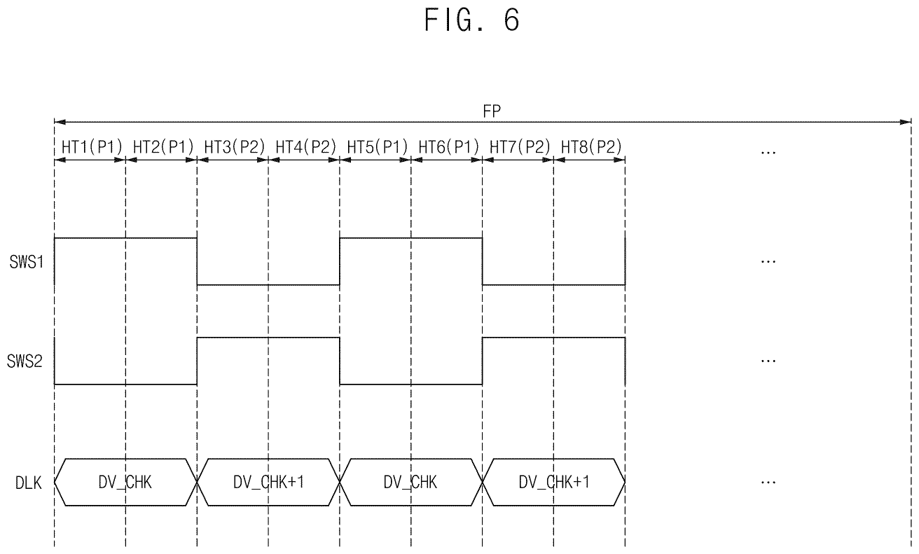

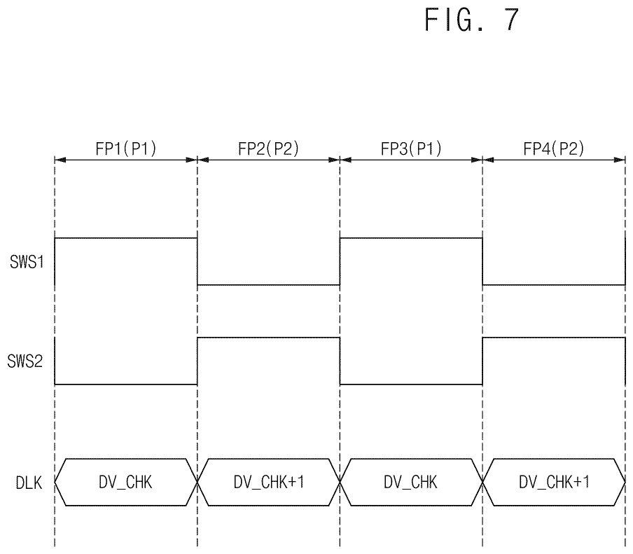

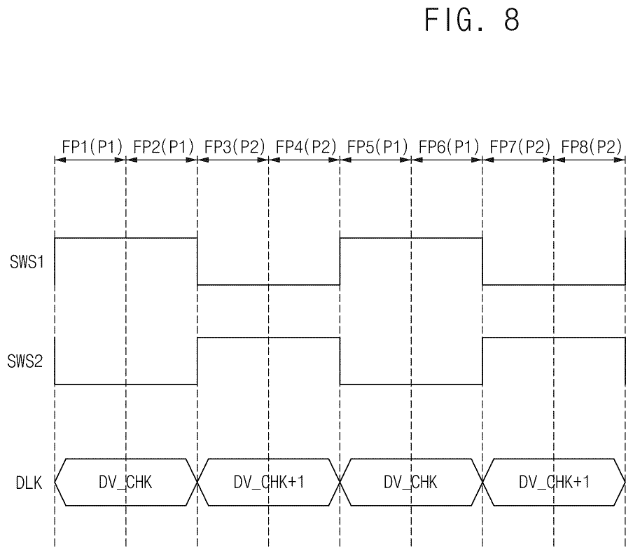

The switching signal generator 150 may generate the first switching signal SWS1 having the active level and the second switching signal SWS2 having an inactive level (e.g., a low level) in the first period, and may generate the first switching signal SWS1 having the inactive level and the second switching signal SWS2 having the active level in the second period. In some embodiments, as illustrated in FIG. 5, the first period and the second period may be alternated with each other per one horizontal time or every horizontal period. In other embodiments, as illustrated in FIG. 6, the first period and the second period may be alternated with each other per L horizontal times or every L horizontal periods, where L is an integer greater than 1. In still other embodiments, as illustrated in FIG. 7, the first period and the second period may be alternated with each other per one frame period. In still other embodiments, as illustrated in FIG. 8, the first period and the second period may be alternated with each other per L frame periods, where L is an integer greater than 1.

In an embodiment, as illustrated in FIG. 2, in the first period P1, in response to the first switching signal SWS1 having the active level, the first switches SW1 of the first multiplexer MUX1 may connect the first through N-th data latches LAT1 through LATN to the first through N-th channel circuits CH1 through CHN, respectively, and the third switches SW3 of the second multiplexer MUX2 may connect the first through N-th data lines DL1 through DLN to the first through N-th channel circuits CH1 through CHN, respectively. Thus, in the first period P1, the first through N-th channel circuits CH1 through CHN may generate data voltages based on image data stored in the first through N-th data latches LAT1 through LATN, and output the data voltages to the first through N-th data lines DL1 through DLN. Further, the (N+1)-th channel circuit CHN+1 may not be connected to the first through N-th data latches LAT1 through LATN and the first through N-th data lines DL1 through DLN in the first period P1.

In such an embodiment, as illustrated in FIG. 3, in the second period P2, in response to the second switching signal SWS2 having the active level, the second switches SW2 of the first multiplexer MUX1 may connect the first through N-th data latches LAT1 through LATN to the second through (N+1)-th channel circuits CH2 through CHN+1, respectively, and the fourth switches SW4 of the second multiplexer MUX2 may connect the first through N-th data lines DL1 through DLN to the second through (N+1)-th channel circuits CH2 through CHN+1, respectively. Thus, in the second period P2, the second through (N+1)-th channel circuits CH2 through CHN+1 may generate data voltages based on image data stored in the first through N-th data latches LAT1 through LATN, and may output the data voltages to the first through N-th data lines DL1 through DLN. Further, the first channel circuit CH1 may not be connected to the first through N-th data latches LAT1 through LATN and the first through N-th data lines DL1 through DLN in the second period P2.

Accordingly, since the first through N-th data lines DL1 through DLN respectively receive the data voltages from the first through N-th channel circuits CH1 through CHN in the first period P1, and respectively receive the data voltages from the second through (N+1)-th channel circuits CH2 through CHN+1 in the second period P2, a voltage deviation or an offset between the data voltages output to the first through N-th data lines DL1 through DLN by the data driver 100 according to embodiments may be substantially reduced.

FIG. 4 illustrates an example of a distribution 220 of the data voltages output to the first through N-th data lines DL1 through DLN in the first period P1, an example of a distribution 240 of the data voltages output to the first through N-th data lines DL1 through DLN in the second period P2, and an example of a distribution 260 of average data voltages between the data voltages in the first period P1 and the data voltages in the second period P2. In an embodiment, for example, as illustrated in FIG. 4, in the first period P1, the K-th channel circuit may output a first data voltage DV1 to the K-th data line DLK, and the first data voltage DV1 may have a first offset OFS1 with respect to an average AVG_DV of all data voltages output to the first through N-th data lines DL1 through DLN. In the example of FIG. 4, the first offset OFS1 of the first data voltage DV1 output by the K-th channel circuit may be the largest offset among offsets of the data voltages output to the first through N-th data lines DL1 through DLN, and in this case, the first offset OFS1 may be referred to as a deviation voltage output (“DVO”) of the data driver 100. In this case, the image quality may be degraded by the first offset OFS1 (or the DVO), or the data driver 100 may be discarded if the first offset OFS1 (or the DVO) is greater than a reference offset. However, in the data driver 100 according to embodiments, in the second period P2, a (K+1)-th channel circuit may output a second data voltage DV2 having an offset less than the first offset OFS1 to the K-th data line DLK. Further, as described below with reference to FIGS. 5 to 8, the first period P1 and the second period P2 may be periodically alternated with each other. Thus, the data voltage output to the K-th data line DLK may correspond to an average ADV of the first data voltage DV1 and the second data voltage DV2, and the offset of the data voltage output to the K-th data line DLK may be reduced from the first offset OFS1 to a second offset OFS2 as shown in FIG. 4. Thus, even in a case where the first offset OFS1 by the K-th channel circuit is greater than the reference offset, the offset of the data voltage output to the K-th data line DLK may become less than or equal to the reference offset such that the image quality may be improved or data driver 100 may be effectively prevented from being discarded.

As described above, the data driver 100 according to embodiments may include the first through (N+1)-th channel circuits CH1 through CHN+1 with respect to the first through N-th data lines DL1 through DLN. In the first period P1, the first through N-th channel circuits CH1 through CHN may output the data voltages to the first through N-th data lines DL1 through DLN, respectively. In the second period P2, the second through (N+1)-th channel circuits CH2 through CHN+1 may output the data voltages to the first through N-th data lines DL1 through DLN, respectively. The first period P1 and the second period P2 may be periodically alternated with each other. Accordingly, the voltage deviation or the offset between the data voltages output to the first through N-th data lines DL1 through DLN may be substantially reduced, and the DVO of the data driver 100 may be substantially reduced.

FIG. 5 is a signal timing diagram for describing an example of an operation of a data driver according to embodiments.

Referring to FIGS. 1 and 5, the first period P1 in which the first through N-th channel circuits CH1 through CHN respectively output the data voltages to the first through N-th data lines DL1 through DLN and the second period P2 in which the second through (N+1)-th channel circuits CH2 through CHN+1 respectively output the data voltages to the first through N-th data lines DL1 through DLN may be alternated with each other per one horizontal time. Here, the horizontal time (or horizontal period) may be a time duration or period allocated to one pixel row of the display panel, and may correspond to a time duration obtained by dividing the frame period FP by the number of pixel rows of the display panel.

In a first horizontal time HT1 in which the data voltages are provided to a first pixel row, the first switching signal SWS1 may have the active level (e.g., the high level), and the second switching signal SWS2 may have the inactive level (e.g., the low level). Thus, in response to the first switching signal SWS1 having the active level, the first switches SW1 of the first multiplexer MUX1 may connect the first through N-th data latches LAT1 through LATN to the first through N-th channel circuits CH1 through CHN, respectively, and the third switches SW3 of the second multiplexer MUX2 may connect the first through N-th data lines DL1 through DLN to the first through N-th channel circuits CH1 through CHN, respectively. In this case, the K-th channel circuit may output the data voltage DV_CHK to the K-th data line DLK.

Thereafter, in a second horizontal time HT2 in which the data voltages are provided to a second pixel row, the first switching signal SWS1 may have the inactive level, and the second switching signal SWS2 may have the active level. Thus, in response to the second switching signal SWS2 having the active level, the second switches SW2 of the first multiplexer MUX1 may connect the first through N-th data latches LAT1 through LATN to the second through (N+1)-th channel circuits CH2 through CHN+1, respectively, and the fourth switches SW4 of the second multiplexer MUX2 may connect the first through N-th data lines DL1 through DLN to the second through (N+1)-th channel circuits CH2 through CHN+1, respectively. In this case, the (K+1)-th channel circuit may output the data voltage DV_CHK+1 to the K-th data line DLK.

Thereafter, in a third horizontal time HT3 at which the data voltages are provided to a third pixel row, the first switching signal SWS1 may have the active level, and the second switching signal SWS2 may have the inactive level. Further, in a fourth horizontal time HT4 in which the data voltages are provided to a fourth pixel row, the first switching signal SWS1 may have the inactive level and the second switching signal SWS2 may have the active level. Thus, the first through N-th channel circuits CH1 through CHN may output the data voltages to the first through N-th data lines DL1 through DLN in odd-numbered horizontal times HT1, HT3, etc. of the frame period FP, and the second through (N+1)-th channel circuits CH2 through CHN+1 may output the data voltages to the first through N-th data lines DL1 through DLN in even-numbered horizontal times HT2, HT4, etc. of the frame period FP. Accordingly, the data voltage output to the K-th data line DLK may be alternated between the data voltage DV_CHK generated by the K-th channel circuit and the data voltage DV_CHK+1 generated by the (K+1)-th channel circuit, and the offset of the data voltage output to the K-th data line DLK may be reduced.

FIG. 6 is a signal timing diagram for describing another example of an operation of a data driver according to embodiments.

Referring to FIGS. 1 and 6, the first period P1 in which the first through N-th channel circuits CH1 through CHN respectively output the data voltages to the first through N-th data lines DL1 through DLN and the second period P2 in which the second through (N+1)-th channel circuits CH2 through CHN+1 respectively output the data voltages to the first through N-th data lines DL1 through DLN may be alternated with each other per L horizontal times, where L is an integer greater than 1. Although FIG. 6 illustrates an embodiment in which L is 2, the cycle in which the first period P1 and the second period P2 are alternated with each other is not limited to the example of FIG. 6.

In an embodiment, for example, as illustrated in FIG. 6, in first, second, fifth and sixth horizontal times HT1, HT2, HT5 and HT6, the first switching signal SWS1 may have the active level (e.g., the high level), the second switching signal SWS2 may have the inactive level (e.g., the low level), and the first through N-th channel circuits CH1 through CHN may output the data voltages to the first through N-th data lines DL1 through DLN, respectively. In such an embodiment, in third, fourth, seventh and eighth horizontal periods HT3, HT4, HT7 and HT8, the first switching signal SWS1 may have the inactive level, the second switching signal SWS2 may have the active level, and the second through (N+1)-th channel circuits CH2 through CHN+1 may output the data voltages to the first through N-th data lines DL1 through DLN, respectively. Accordingly, the data voltage output to the K-th data line DLK may be alternated between the data voltage DV_CHK generated by the K-th channel circuit and the data voltage DV_CHK+1 generated by the (K+1)-th channel circuit, and the offset of the data voltage output to the K-th data line DLK may be reduced.

FIG. 7 is a signal timing diagram for describing still another example of an operation of a data driver according to embodiments.

Referring to FIGS. 1 and 7, the first period P1 in which the first through N-th channel circuits CH1 through CHN respectively output the data voltages to the first through N-th data lines DL1 through DLN and the second period P2 in which the second through (N+1)-th channel circuits CH2 through CHN+1 respectively output the data voltages to the first through N-th data lines DL1 through DLN may be alternated with each other per one frame period FP.

In an embodiment, for example, as illustrated in FIG. 7, in odd-numbered frame periods FP1, FP3, etc., the first switching signal SWS1 may have the active level (e.g., the high level), the second switching signal SWS2 may have the inactive level (e.g., the low level), and the first through N-th channel circuits CH1 through CHN may output the data voltages to the first through N-th data lines DL1 through DLN, respectively. In such an embodiment, in even-numbered frame periods FP2, FP4, etc., the first switching signal SWS1 may have the inactive level, the second switching signal SWS2 may have the active level, and the second through (N+1)-th channel circuits CH2 through CHN+1 may output the data voltages to the first through N-th data lines DL1 through DLN, respectively. Accordingly, the data voltage output to the K-th data line DLK may be alternated between the data voltage DV_CHK generated by the K-th channel circuit and the data voltage DV_CHK+1 generated by the (K+1)-th channel circuit, and the offset of the data voltage output to the K-th data line DLK may be reduced.

FIG. 8 is a signal timing diagram for describing still another example of an operation of a data driver according to embodiments.

Referring to FIGS. 1 and 8, the first period P1 in which the first through N-th channel circuits CH1 through CHN respectively output the data voltages to the first through N-th data lines DL1 through DLN and the second period P2 in which the second through (N+1)-th channel circuits CH2 through CHN+1 respectively output the data voltages to the first through N-th data lines DL1 through DLN may be alternated with each other per L frame periods, where L is an integer greater than 1. Although FIG. 8 illustrates an embodiment in which L is 2, the cycle in which the first period P1 and the second period P2 are alternated with each other is not limited to the example of FIG. 8.

In an embodiment, for example, as illustrated in FIG. 8, in first, second, fifth and sixth frame periods FP1, FP2, FP5 and FP6, the first switching signal SWS1 may have the active level (e.g., the high level), the second switching signal SWS2 may have the inactive level (e.g., the low level), and the first through N-th channel circuits CH1 through CHN may output the data voltages to the first through N-th data lines DL1 through DLN, respectively. In such an embodiment, in third, fourth, seventh and eighth frame periods FP3, FP4, FP7 and FP8, the first switching signal SWS1 may have the inactive level, the second switching signal SWS2 may have the active level, and the second through (N+1)-th channel circuits CH2 through CHN+1 may output the data voltages to the first through N-th data lines DL1 through DLN, respectively. Accordingly, the data voltage output to the K-th data line DLK may be alternated between the data voltage DV_CHK generated by the K-th channel circuit and the data voltage DV_CHK+1 generated by the (K+1)-th channel circuit, and the offset of the data voltage output to the K-th data line DLK may be reduced.

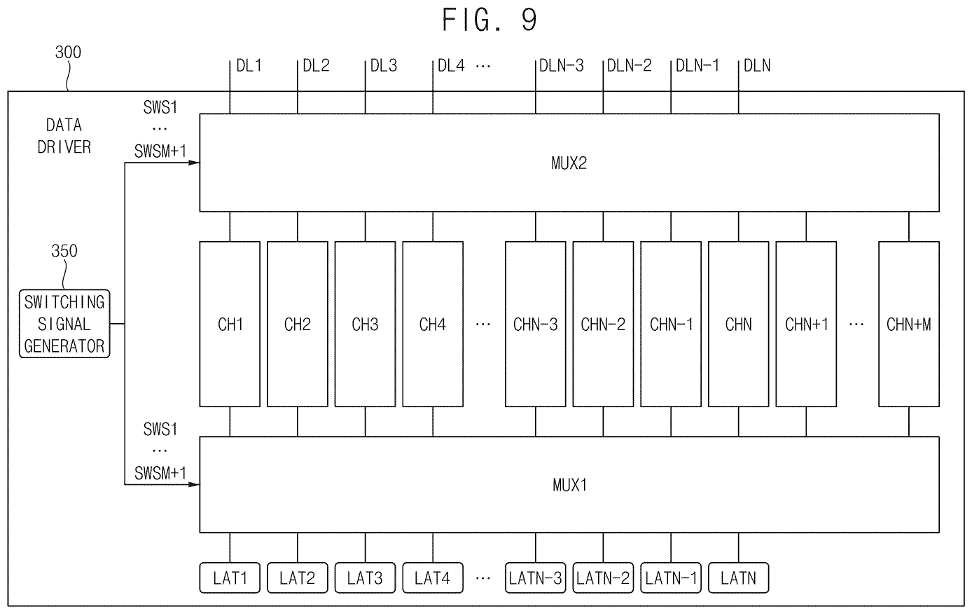

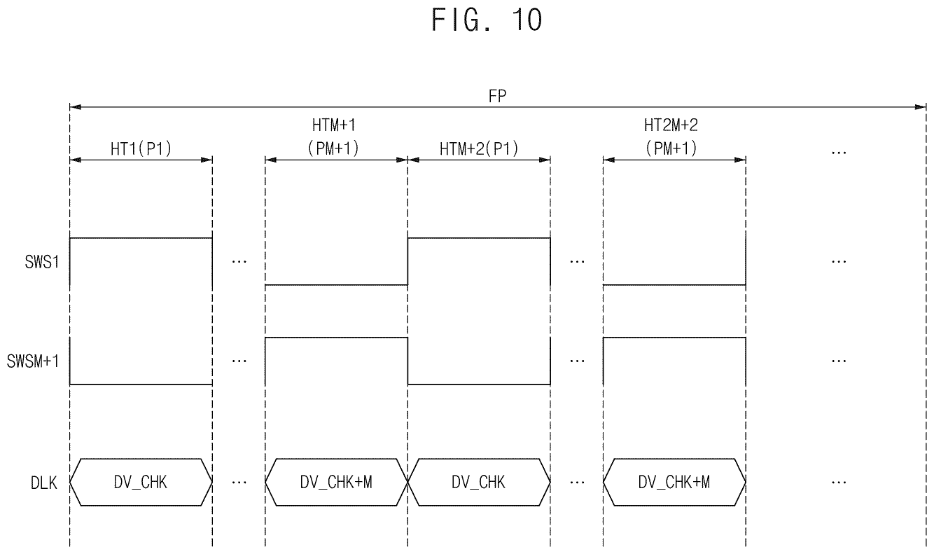

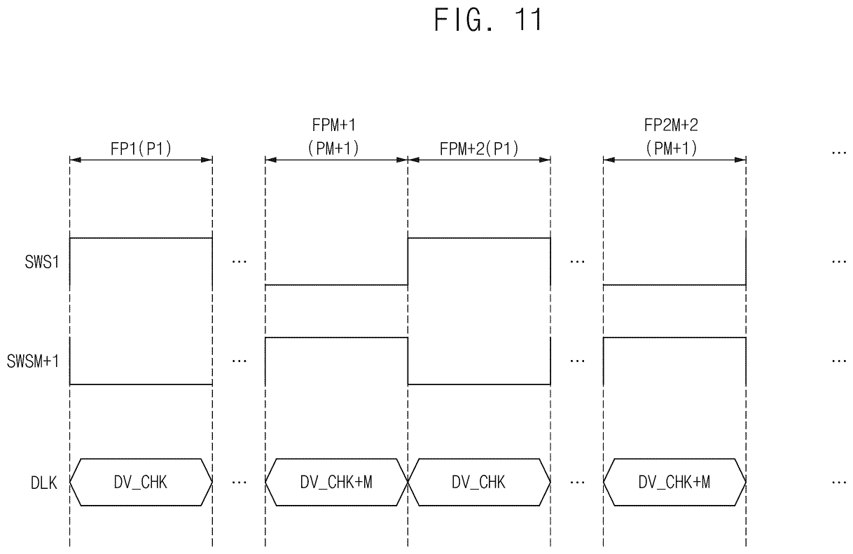

FIG. 9 is a block diagram illustrating a data driver according to embodiments, FIG. 10 is a signal timing diagram for describing an example of an operation of a data driver according to embodiments, and FIG. 11 is a signal timing diagram for describing another example of an operation of a data driver according to embodiments.

Referring to FIG. 9, a data driver 300 according to embodiments may include first through N-th data latches LAT1 through LATN, first through (N+M)-th channel circuits CH1, CH2, CH3, CH4, . . . , CHN-3, CHN-2, CHN-1, CHN, CHN+1, . . . , and CHN+M, where M is an integer greater than 1, a first multiplexer MUX1 connected between the first through N-th data latches LAT1 through LATN and the first through (N+M)-th channel circuits CH1 through CHN+M, a second multiplexer MUX2 connected between the first through (N+M)-th channel circuits CH1 through CHN+M and first through N-th data lines DL1 through DLN, and a switching signal generator 350. The data driver 300 of FIG. 9 may have a similar configuration and a similar operation to a data driver 100 of FIG. 1, except that the data driver 300 may include the first through (N+M)-th channel circuits CH1 through CHN+M with respect to the first through N-th data lines DL1 through DLN.

The switching signal generator 350 may generate first through (M+1)-th switching signals SWS1, . . . , and SWSM+1. In a (P+1)-th period, where P is an integer greater than or equal to 0 and less than or equal to M, a (P+1)-th switching signal among the first through (M+1)-th switching signals SWS1, . . . , and SWSM+1 may have an active level. In an embodiment, for example, the first switching signal SWS1 may have the active level in the first period, and the (M+1)-th switching signal SWSM+1 may have the active level in the (M+1)-th period. Further, in the (P+1)-th period, the first multiplexer MUX1 may respectively connect the first through N-th data latches LAT1 through LATN to (P+1)-th through (N+P)-th channel circuits, and the second multiplexer MUX2 may respectively connect the first through N-th data lines DL1 through DLN to the (P+1)-th through (N+P)-th channel circuits. Thus, in the (P+1)-th period, a (K+P)-th channel circuit may output a data voltage to a K-th data line DLK. In an embodiment, for example, in the first period, the first multiplexer MUX1 may respectively connect the first through N-th data latches LAT1 through LATN to the first through N-th channel circuits CH1 through CHN, and the second multiplexer MUX2 may respectively connect the first through N-th data lines DL1 through DLN to the first through N-th channel circuits CH1 through CHN. Further, in the (M+1)-th period, the first multiplexer MUX1 may respectively connect the first through N-th data latches LAT1 through LATN to (M+1)-th through (N+M)-th channel circuits . . . , CHN+M, and the second multiplexer MUX2 may respectively connect the first through N-th data lines DL1 through DLN to the (M+1)-th through (N+M)-th channel circuits . . . , CHN+M.

In some embodiments, as illustrated in FIG. 10, the first period P1 through the (M+1)-th period PM+1 may be alternated with each other per one horizontal time. In an embodiment, for example, the first through (M+1)-th switching signals SWS1, . . . , and SWSM+1 may have the active level in first through (M+1)-th horizontal times HT1, . . . , and HTM+1, respectively. Thus, the K-th through (K+M)-th channel circuits may output data voltages DV_CHK, . . . , and DV_CHK+M to the K-th data line DLK in the first through (M+1)-th horizontal periods HT1, . . . , and HTM+1, respectively. In such embodiments, the first through (M+1)-th switching signals SWS1, . . . , and SWSM+1 may sequentially have the active level in (M+2)-th through (2M+2)-th horizontal periods HTM+2, . . . , and HT2M+2, and the K-th through (K+M)-th channel circuits may output data voltages DV_CHK, . . . , and DV_CHK+M to the K-th data line DLK in (M+2)-th through (2M+2)-th horizontal periods HTM+2, . . . , and HT2M+2, respectively. Accordingly, the offset of the data voltages DV_CHK, . . . , and DV_CHK+M output to the K-th data line DLK may be reduced. FIG. 10 illustrates an embodiment in which the first period P1 through the (M+1)-th period PM+1 are alternated with each other per one horizontal time as an example. In other embodiments, the first period P1 through the (M+1)-th period PM+1 may be alternated with each other per two or more horizontal times.

In other embodiments, as illustrated in FIG. 11, the first period P1 through the (M+1)-th period PM+1 may be alternated with each other per one frame period. In an embodiment, for example, the first through (M+1)-th switching signals SWS1, . . . , and SWSM+1 may sequentially have the active level in first through (M+1)-th frame periods FP1, . . . , and FPM+1, and the K-th through (K+M)-th channel circuits may output the data voltages DV_CHK, . . . , and DV_CHK+M to the K-th data line DLK in the first through (M+1)-th frame periods FP1, . . . , and FPM+1, respectively. In such embodiments, the first through (M+1)-th switching signals SWS1, . . . , and SWSM+1 may sequentially have the active level in (M+2)-th through (2M+2)-th frame periods FPM+2, ..., and FP2M+2, and the K-th through (K+M)-th channel circuits may output the data voltages DV_CHK, . . . , and DV_CHK+M to the K-th data line DLK in the (M+2)-th through (2M+2)-th frame periods FPM+2, . . . , and FP2M+2, respectively. Accordingly, the offset of the data voltages DV_CHK, . . . , and DV_CHK+M output to the K-th data line DLK may be reduced. FIG. 11 illustrates an embodiment in which the first period P1 through the (M+1)-th period PM+1 are alternated with each other per one frame period as an example. In other embodiments, the first period P1 through the (M+1)-th period PM+1 may be alternated with each other per two or more frame periods.

As described above, the data driver 300 according to embodiments may include the first through (N+M)-th channel circuits CH1 through CHN+M with respect to the first through N-th data lines DL1 through DLN. In the first period P1, the first through N-th channel circuits CH1 through CHN may output the data voltages to the first through N-th data lines DL1 through DLN, respectively, and in the (M+1)-th period (PM+1), the (M+1)-th through (N+M)-th channel circuits . . . , CHN+M may output the data voltages to the first through N-th data lines DL1 through DLN, respectively. Accordingly, the voltage deviation or the offset between the data voltages output to the first through N-th data lines DL1 through DLN may be reduced, and the DVO of the data driver 300 may be improved or reduced.

FIG. 12 is a block diagram illustrating a display device according to embodiments.

Referring to FIG. 12, a display device 700 according to embodiments may include a display panel 710, a data driver 720, a scan driver 730 and a controller 750. In some embodiments, the display device 700 may further include an emission driver 740.

The display panel 710 may include first through N-th data lines, and a plurality of pixels PX connected to the first through N-th data lines. In some embodiments, each pixel PX may include at least two transistors, at least one capacitor and a light-emitting element, and the display panel 710 may be a light-emitting display panel. In an embodiment, for example, the light-emitting element may be an organic light-emitting diode (“OLED”), a nano light-emitting diode (“NED”), a quantum dot (“QD”) light-emitting diode, a micro light-emitting diode, an inorganic light-emitting diode, or any other suitable light-emitting element. Further, the display panel 710 is not limited to the light-emitting display panel, and may be any suitable display panel.

The data driver 720 may provide data voltages DV to the plurality of pixels PX based on a data control signal DCTRL and output image data ODAT received from the controller 750. The data control signal DCTRL may include, but is not limited to, an output data enable signal, a horizontal start signal and a load signal. According to embodiments, the data driver 720 may be a data driver 100 illustrated in FIG. 1, a data driver 300 illustrated in FIG. 9, or the like. In embodiments, first through N-th channel circuits of the data driver 720 may respectively output the data voltages DV to the first through N-th data lines in a first period, and second through (N+1)-th channel circuits of the data driver 720 may respectively output the data voltages DV to the first through N-th data lines in a second period. Accordingly, a voltage deviation or an offset between the data voltages DV output to the first through N-th data lines may be reduced. In some embodiments, the data driver 720 and the controller 750 may be implemented as a single integrated circuit, and the single integrated circuit may be referred to as a timing controller embedded data driver (“TED”) integrated circuit. In other embodiments, the data driver 720 and the controller 750 may be implemented as separate integrated circuits.

The scan driver 730 may provide scan signals SS to the plurality of pixels PX based on a scan control signal SCTRL received from the controller 750. The scan control signal SCTRL may include, but is not limited to, a scan start signal and a scan clock signal. In some embodiments, the scan driver 730 may be integrated or formed in the display panel 710. In other embodiments, the scan driver 730 may be implemented with one or more integrated circuits.

The emission driver 740 may provide emission signals EM to the plurality of pixels PX based on an emission control signal EMCTRL received from the controller 750. The emission control signal EMCTRL may include, but is not limited to, an emission start signal and an emission clock signal. In some embodiments, the emission driver 740 may be integrated or formed in the display panel 710. In other embodiments, the emission driver 740 may be implemented with one or more integrated circuits.

The controller 750 (e.g., a timing controller) may receive input image data IDAT and a control signal CTRL from an external processor (e.g., a graphics processing unit (“GPU”), an application processor (“AP”) or a graphics card). In some embodiments, the control signal CTRL may include, but is not limited to, a vertical synchronization signal, a horizontal synchronization signal, an input data enable signal, a master clock signal, etc. The controller 750 may generate the output image data ODAT, the data control signal DCTRL, the scan control signal SCTRL and the emission control signal EMCTRL based on the input image data IDAT and the control signal CTRL. The controller 750 may control the data driver 720 by providing the output image data ODAT and the data control signal DCTRL to the data driver 720, may control the scan driver 730 by providing the scan control signal SCTRL to the scan driver 730, and may control the emission driver 740 by providing the emission control signal EMCTRL to the emission driver 740.

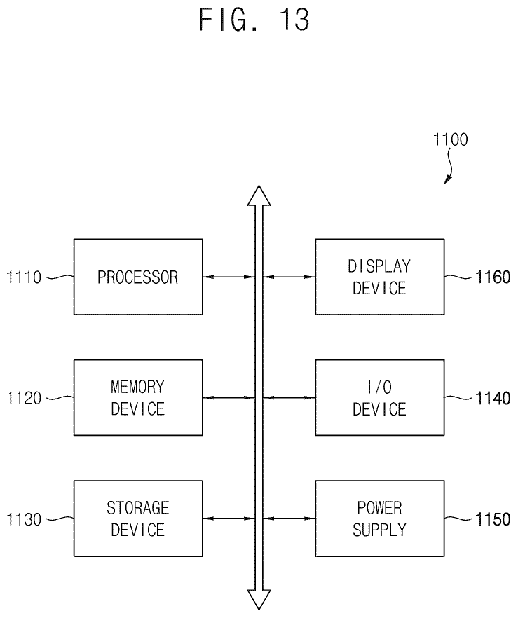

FIG. 13 is a block diagram illustrating an electronic device including a display device according to embodiments.

Referring to FIG. 13, an embodiment of an electronic device 1100 may include a processor 1110, a memory device 1120, a storage device 1130, an input/output (I/O) device 1140, a power supply 1150 and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, in some embodiments, the processor 1110 may be further coupled to an extended bus such as a peripheral component interconnection (“PCI”) bus.

The memory device 1120 may store data for operations of the electronic device 1100. In an embodiment, for example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In the display device 1160, as described above, a data driver may include first through (N+1)-th channel circuits with respect to first through N-th data lines, where N is an integer greater than 1. In a first period, the first through N-th channel circuits may output data voltages to the first through N-th data lines, respectively. In a second period, second through (N+1)-th channel circuits may output data voltages to the first through N-th data lines, respectively. Accordingly, a voltage deviation or an offset between the data voltages output to the first through N-th data lines may be reduced.

The inventive concepts may be applied any electronic device 1100 including the display device 1160. In an embodiment, for example, the inventive concepts may be applied to a virtual reality (“VR”) device, an augmented reality (“AR”) device, a mixed reality (“MR”) device, an extended reality (“XR”) device, a mobile phone, a smart phone, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

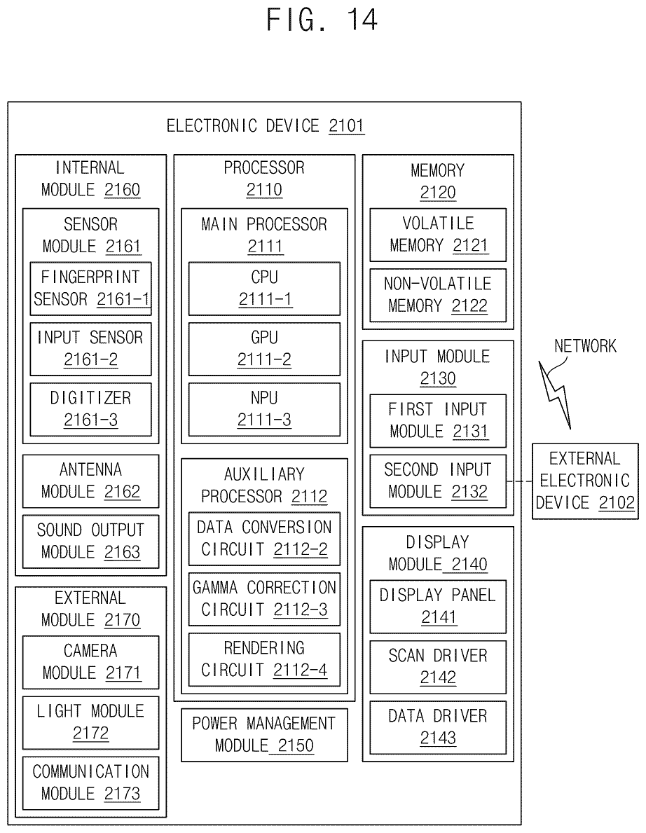

FIG. 14 is a block diagram illustrating an example of an electronic device according to embodiments.

An embodiment of an electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

As another example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

As still another example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 14, an embodiment of the electronic device 2101 may communicate with an external electronic device 2102 via a network (e.g., a short-range wireless communication network or a long-range wireless communication network). In some embodiments, the electronic device 2101 may include the processor 2110, the memory 2120, the input module 2130, the display module 2140, a power management module 2150, an internal module 2160 and an external module 2170. In some embodiments, at least one of the components may be omitted from the electronic device 2101, or one or more other components may be added in the electronic device 2101. In some embodiments, some of the components (e.g., the sensor module 2161, an antenna module 2162, or the sound output module 2163) may be implemented as a single component (e.g., the display module 2140).

The processor 2110 may execute software to control at least one other component (e.g., a hardware or software component) of the electronic device 2101 coupled with the processor 2110, and may perform various data processing or computation. According to some embodiments, as at least part of the data processing or computation, the processor 2110 may store a command or data received from another component (e.g., the input module 2130, the sensor module 2161 or a communication module 2173) in a volatile memory 2121, may process the command or the data stored in the volatile memory 2121, and may store resulting data in a non-volatile memory 2122.

The processor 2110 may include a main processor 2111 and an auxiliary processor 2112. The main processor 2111 may include at least one selected from a central processing unit (“CPU”) 2111-1 or an application processor (“AP”). The main processor 2111 may further include at least one selected from a graphics processing unit (“GPU”) 2111-2, a communication processor (“CP”), and an image signal processor (“ISP”). The main processor 2111 may further include a neural processing unit (“NPU”) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (“DNN”), a convolutional neural network (“CNN”), a recurrent neural network (“RNN”), a restricted Boltzmann machine (“RBM”), a deep belief network (“DBN”), a bidirectional recurrent deep neural network (“BRDNN”), deep Q-network or a combination of two or more thereof, but is not limited thereto. The artificial intelligence model may, additionally or alternatively, include a software structure other than a hardware structure. At least two selected from the above-described processing units and processors may be implemented as an integrated component (e.g., a single chip), or respective processing units and processors may be implemented as independent components (e.g., a plurality of chips).

The auxiliary processor 2112 may include a controller. The controller included in the auxiliary processor 2112 may correspond to a controller 750 illustrated in FIG. 12. The controller may include an interface conversion circuit and a timing control circuit. The controller may receive an image signal from the main processor 2111, may convert a data format of the image signal to meet interface specifications with the display module 2140, and may output image data. The controller may output various control signals required for driving the display module 2140.

The auxiliary processor 2112 may further include a data conversion circuit 2112-2, a gamma correction circuit 2112-3, a rendering circuit 2112-4, or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller, and may render the image data in consideration of a pixel arrangement of the display panel 2141 in the electronic device 2101. At least one selected from the data conversion circuit 2112-2, the gamma correction circuit 2112-3 and the rendering circuit 2112-4 may be integrated in another component (e.g., the main processor 2111 or the controller). At least one selected from the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one of the volatile memory 2121 and the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In some embodiments, the second input module 2132 may include a high definition multimedia interface (“HDMI”), a universal serial bus (“USB”) interface, an SD card interface or an audio interface. The second input module 2132 may include a connector that may physically connect the electronic device 2101 to the external electronic device 2102. In an embodiment, for example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is not limited thereto. The display panel 2141 may be a rigid type display panel, or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. Alternatively, the scan driver 2142 may be integrated into the display panel 2141. In an embodiment, for example, the scan driver 2142 may include an amorphous silicon TFT gate driver circuit (“ASG”), a low temperature polycrystalline silicon (“LTPS”) TFT gate driver circuit or an oxide semiconductor TFT gate driver circuit (“OSG”) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and then may output the data voltages to the display panel 2141. In an embodiment, as described above, the data driver 2143 may include first through (N+1)-th channel circuits with respect to first through N-th data lines, where N is an integer greater than 1. In a first period, the first through N-th channel circuits may output data voltages to the first through N-th data lines, respectively. In a second period, second through (N+1)-th channel circuits may output data voltages to the first through N-th data lines, respectively. Accordingly, a voltage deviation or an offset between the data voltages output to the first through N-th data lines may be reduced.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit, or the like. The voltage generator circuit may output various voltages used to drive the display panel 2141.

The power management module 2150 may supply power to the components of the electronic device 2101. The power management module 2150 may include a battery that supplies a power supply voltage. The battery may include a primary cell which is not rechargeable, a secondary cell which is rechargeable, or a fuel cell. The power management module 2150 may include a power management integrated circuit (“PMIC”). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131, and may generate an electrical signal or data value corresponding to the input. The sensor module 2161 may include at least one of the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include at least one selected from an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen, or may transmit/receive data to/from the active pen.

The input sensor 2161-2 may measure a bio-signal, such as blood pressure, moisture or body fat. In an embodiment, for example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transmit/receive data to/from the active pen.

At least one selected from the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141, or at least one selected from the fingerprint sensor 2161-1, the input sensor 2161-2 and the digitizer 2161-3 may be disposed below the display panel 2141.

Two or more selected from the fingerprint sensor 2161-1, the input sensor 2161-2 and the digitizer 2161-3 may be integrated into one sensing panel through the same process. In such an embodiment, where two or more selected from the fingerprint sensor 2161-1, the input sensor 2161-2 and the digitizer 2161-3 are integrated into one sensing panel, the sensing panel may be disposed between the display panel 2141 and a window disposed above the display panel 2141. In some embodiments, the sensing panel may be disposed on the window, but the location of the sensing panel is not limited thereto.

At least one selected from the fingerprint sensor 2161-1, the input sensor 2161-2 and the digitizer 2161-3 may be embedded in the display panel 2141. In other words, at least one selected from the fingerprint sensor 2161-1, the input sensor 2161-2 and the digitizer 2161-3 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (“IR”) sensor, a biometric sensor, a temperature sensor, a humidity sensor or an illuminance sensor.

The antenna module 2162 may include one or more antennas for transmitting or receiving a signal or power to or from the outside. In some embodiments, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In some embodiments, the receiver may be implemented as separate from, or as part of the speaker. A sound output pattern of the sound output module 2163 may be integrated into the display module 2140.

The camera module 2171 may capture a still image and a moving image. In some embodiments, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171, or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (“GNSS”) communication module) or a wired communication module (e.g., a local area network (“LAN”) communication module or a power line communication (“PLC”) module). The communication module 2173 may communicate with the external electronic device 2102 via a short-range communication network (e.g., Bluetooth™, wireless-fidelity (“Wi-Fi”) direct, or infrared data association (“IrDA”)) or a long-range communication network (e.g., a cellular network, the Internet or a computer network (e.g., LAN or wide area network (“WAN”))). These various types of communication modules 2173 may be implemented as a single chip, or may be implemented as multi-chips separate from each other.

The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. In an embodiment, for example, the processor 2110 may generate image data corresponding to input data applied through a mouse or an active pen, and may output the image data to the display module 2140. Alternatively, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. In an embodiment, for example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161, and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. In an embodiment, for example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least some of the above-described components may be coupled mutually and communicate signals (e.g., commands or data) therebetween via an inter-peripheral communication scheme (e.g., a bus, general purpose input and output (“GPIO”), serial peripheral interface (“SPI”), mobile industry processor interface (“MIPI”) or ultra-path interconnect (“UPI”)). The processor 2110 may communicate with the display module 2140 via an agreed interface. Further, at least one selected from the above-described communication methods may be used between the processor 2110 and the display module 2140, but the communication method between the processor 2110 and the display module 2140 is not limited to the above-described communication method.

The electronic device 2101 according to various embodiments described above may be various types of devices. In an embodiment, for example, the electronic device 2101 may include at least one of a portable communication device (e.g., a smart phone), a computer device, a portable multimedia device, a portable medical device, a camera, a wearable device and a home appliance. However, the electronic device 2101 according to embodiments is not limited to the above-described devices.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A data driver of a display device, the data driver comprising:
first through N-th data latches, wherein N is an integer greater than 1;
first through (N+1)-th channel circuits;
a first multiplexer connected between the first through N-th data latches and the first through (N+1)-th channel circuits; and
a second multiplexer connected between the first through (N+1)-th channel circuits and first through N-th data lines,
wherein in a first period, the first multiplexer connects the first through N-th data latches to the first through N-th channel circuits, respectively, and the second multiplexer connects the first through N-th data lines to the first through N-th channel circuits, respectively, and
wherein, in a second period, the first multiplexer connects the first through N-th data latches to second through (N+1)-th channel circuits, respectively, and the second multiplexer connects the first through N-th data lines to the second through (N+1)-th channel circuits, respectively.

2. The data driver of claim 1, wherein, in the first period, a K-th channel circuit among the first through (N+1)-th channel circuits outputs a data voltage to a K-th data line among the first through N-th data lines, wherein K is an integer greater than or equal to 1 and less than or equal to N, and
wherein, in the second period, a (K+1)-th channel circuit among the first through (N+1)-th channel circuits outputs a data voltage to the K-th data line.

3. The data driver of claim 1, wherein a K-th channel circuit among the first through (N+1)-th channel circuits includes:
a level shifter which performs a level shifting operation on image data received from a K-th data latch among the first through N-th data latches in the first period, and performs a level shifting operation on image data received from a (K−1)-th data latch among the first through N-th data latches in the second period;
a digital-to-analog converter which generates a data voltage by performing a digital-to-analog conversion operation on image data output from the level shifter; and
an output buffer which outputs the data voltage to a K-th data line among the first through N-th data lines in the first period, and outputs the data voltage to a (K−1)-th data line among the first through N-th data lines in the second period,
wherein K is an integer greater than or equal to 2 and less than or equal to N.

4. The data driver of claim 1, wherein the first channel circuit is not connected to the first through N-th data latches and the first through N-th data lines in the second period, and
wherein the (N+1)-th channel circuit is not connected to the first through N-th data latches and the first through N-th data lines in the first period.

5. The data driver of claim 1, wherein the first multiplexer includes:
a plurality of first switches which connects the first through N-th data latches to the first through N-th channel circuits in response to a first switching signal, respectively; and
a plurality of second switches which connects the first through N-th data latches to the second through (N+1)-th channel circuits in response to a second switching signal, respectively.

6. The data driver of claim 5, wherein the second multiplexer includes:
a plurality of third switches which connects the first through N-th data lines to the first through N-th channel circuits in response to the first switching signal, respectively; and
a plurality of fourth switches which connects the first through N-th data lines to the second through (N+1)-th channel circuits in response to the second switching signal, respectively.

7. The data driver of claim 6, further comprising:
a switching signal generator which generates the first switching signal having an active level in the first period, and generates the second switching signal having an active level in the second period.

8. The data driver of claim 1, wherein the first period and the second period are alternated with each other per one horizontal time.

9. The data driver of claim 8, wherein, in an odd-numbered horizontal time of a frame period, the first through N-th channel circuits output data voltages to the first through N-th data lines, and
wherein, in an even-numbered horizontal time of the frame period, the second through (N+1)-th channel circuits output data voltages to the first through N-th data lines.

10. The data driver of claim 1, wherein the first period and the second period are alternated with each other per L horizontal times, where L is an integer greater than 1.

11. The data driver of claim 1, wherein the first period and the second period are alternated with each other per one frame period.

12. The data driver of claim 11, wherein, in an odd-numbered frame period, the first through N-th channel circuits output data voltages to the first through N-th data lines, and
wherein, in an even-numbered frame period, the second through (N+1)-th channel circuits output data voltages to the first through N-th data lines.

13. The data driver of claim 1, wherein the first period and the second period are alternated with each other per L frame periods, where L is an integer greater than 1.

14. A data driver of a display device, the data driver comprising:
first through N-th data latches, wherein N is an integer greater than 1;
first through (N+M)-th channel circuits, wherein M is an integer greater than 1;
a first multiplexer connected between the first through N-th data latches and the first through (N+1)-th channel circuits; and
a second multiplexer connected between the first through (N+1)-th channel circuits and first through N-th data lines,
wherein, in a (P+1)-th period, the first multiplexer connects the first through N-th data latches to (P+1)-th through (N+P)-th channel circuits, respectively, and the second multiplexer connects the first through N-th data lines to the (P+1)-th through (N+P)-th channel circuits, respectively,
wherein P is an integer greater than or equal to 0 and less than or equal to M.

15. The data driver of claim 14, wherein, in the (P+1)-th period, a (K+P)-th channel circuit among the first through (N+M)-th channel circuits outputs a data voltage to a K-th data line among the first through N-th data lines, wherein K is an integer greater than or equal to 1 and less than or equal to N.

16. An electronic device comprising:
a processor which provides input image data; and
a display device which receives the input image data from the processor, and to display an image based on the input image data,
wherein the display device comprises:
a display panel including first through N-th data lines, and a plurality of pixels connected to the first through N-th data lines, wherein N is an integer greater than 1;
a scan driver which provides scan signals to the plurality of pixels;
a data driver which provides data voltages to the plurality of pixels through the first through N-th data lines; and
a controller which controls the scan driver and the data driver,
wherein the data driver comprises:
first through N-th data latches;
first through (N+1)-th channel circuits;
a first multiplexer connected between the first through N-th data latches and the first through (N+1)-th channel circuits; and
a second multiplexer connected between the first through (N+1)-th channel circuits and the first through N-th data lines,
wherein, in a first period, the first multiplexer connects the first through N-th data latches to the first through N-th channel circuits, respectively, and the second multiplexer connects the first through N-th data lines to the first through N-th channel circuits, respectively, and
wherein, in a second period, the first multiplexer connects the first through N-th data latches to second through (N+1)-th channel circuits, respectively, and the second multiplexer connects the first through N-th data lines to the second through (N+1)-th channel circuits, respectively.

17. The electronic device of claim 16, wherein, in the first period, a K-th channel circuit among the first through (N+1)-th channel circuits outputs a data voltage to a K-th data line among the first through N-th data lines, wherein K is an integer greater than or equal to 1 and less than or equal to N, and
wherein, in the second period, a (K+1)-th channel circuit among the first through (N+1)-th channel circuits outputs a data voltage to the K-th data line.

18. The electronic device of claim 16, wherein a K-th channel circuit among the first through (N+1)-th channel circuits includes:
a level shifter which performs a level shifting operation on image data received from a K-th data latch among the first through N-th data latches in the first period, and performs a level shifting operation on image data received from a (K−1)-th data latch among the first through N-th data latches in the second period;
a digital-to-analog converter which generates a data voltage by performing a digital-to-analog conversion operation on image data output from the level shifter; and
an output buffer which outputs the data voltage to a K-th data line among the first through N-th data lines in the first period, and outputs the data voltage to a (K−1)-th data line among the first through N-th data lines in the second period,
wherein K is an integer greater than or equal to 2 and less than or equal to N.

19. The electronic device of claim 16, wherein the first multiplexer includes:
a plurality of first switches which connects the first through N-th data latches to the first through N-th channel circuits in response to a first switching signal, respectively; and
a plurality of second switches which connects the first through N-th data latches to the second through (N+1)-th channel circuits in response to a second switching signal, respectively, and
wherein the second multiplexer includes:
a plurality of third switches which connects the first through N-th data lines to the first through N-th channel circuits in response to the first switching signal, respectively; and
a plurality of fourth switches which connects the first through N-th data lines to the second through (N+1)-th channel circuits in response to the second switching signal, respectively.

20. The electronic device of claim 19, wherein the data driver further comprises:
a switching signal generator which generates the first switching signal having an active level in the first period, and generates the second switching signal having an active level in the second period.
